(19) United States
(12) Patent Application Publication
(10) Pub. No.: US 2024/0192317 A1
(43) Pub. Date: Jun. 13, 2024

(54) SIMULATION DEVICE FOR A SURROUNDINGS SENSOR SYSTEM, AND METHOD FOR OPERATING SUCH A SIMULATION DEVICE

(71) Applicant: dSPACE GmbH, Paderborn (DE)

(72) Inventors: Dirk BERNECK, Paderborn (DE); Andreas HIMMLER, Paderborn (DE); Alexander TRAPP, Paderborn (DE)

(73) Assignee: dSPACE GmbH, Paderborn (DE)

(21) Appl. No.: 18/535,888

(22) Filed: Dec. 11, 2023

(30) Foreign Application Priority Data
Dec. 12, 2022 (DE) 10 2022 133 033.8

(51) Int. Cl. G01S 7/40

(52) U.S. Cl. CPC G01S 7/4052

(57) ABSTRACT

A simulation device and method for a surroundings sensor system configured to detect at least one particular object based on a respective signal echo. A receiving device configured to receive a first signal that is sent from the surroundings sensor system and to convert it into a first operating signal. A signal path that is connected to the receiving device for accepting the first operating signal, the signal path being configured to generate, via a first signal processing, a second operating signal that is a function of the first operating signal and the respective signal echo. The respective signal echo being characterized by at least one signal parameter. A second signal processing being provided to provide the at least one signal parameter with a variation. A transmitting device configured to convert the second operating signal into a second signal and to send the second signal to the surroundings sensor system.

This nonprovisional application claims priority under 35 U.S.C. § 119(a) to German Patent Application No. 10 2022 133 033.8, which was filed in Germany on Dec. 12, 2022, and which is herein incorporated by reference.

### BACKGROUND OF THE INVENTION

### Field of the Invention

The present patent application relates to a simulation device for a surroundings sensor system, and to a method for operating such a simulation device. Surroundings sensor systems may be based on the principle of radar or lidar, for example. Radar sensors are based on electromagnetic waves in the radio frequency range, and lidar sensors are based on electromagnetic waves in the laser frequency range.

### Description of the Background Art

A method for operating a simulator apparatus for testing a distance sensor that operates using electromagnetic waves is known from WO 2020/141151 A1, which corresponds to US 2022/0082658, which is incorporated herein by reference. A desired reflection signal that is provided with a frequency shift is generated corresponding to a signal that is received from the distance sensor. Based on the added frequency shift, the distance sensor may obtain information concerning a relative speed. The distance sensor may be tested by use of the simulator apparatus.

A signal delay apparatus for simulating spatial distances for a distance sensor, based on electromagnetic waves, is known from WO 2020/136279 A1, which corresponds to US 2022/0120856, which is incorporated herein by reference. A desired reflection signal that is provided with a delay is generated corresponding to a signal that is received from the distance sensor. Based on the added delay of the received signal, the distance sensor may obtain distance information. The distance sensor may be tested by use of the simulator apparatus.

### SUMMARY OF THE INVENTION

A surroundings sensor system is configured to detect objects. It can detect at least one particular object based on a respective signal echo. An exemplary simulation device for such a surroundings sensor system is configured to generate a signal echo that corresponds to a particular simulated object. The simulation device includes: a receiving device that is configured to receive a first signal that is sent from the surroundings sensor system and to convert it into a first operating signal; a signal path that is connected to the receiving device for accepting the first operating signal, the signal path being configured to generate, by means of a first signal processing, a second operating signal that is a function of the first operating signal and the respective signal echo, the respective signal echo being characterized by at least one signal parameter, a second signal processing being provided to provide the at least one signal parameter with a variation; and a transmitting device that is configured to convert the second operating signal into a second signal and to send the second signal to the surroundings sensor system.

Furthermore, a method for operating a simulation device for a surroundings sensor system is proposed. The surroundings sensor system is configured to detect at least one particular object based on a respective signal echo. The method comprises the following method steps: reception of a first signal, sent by the surroundings sensor system, by a receiving device; conversion of the first signal into a first operating signal by the receiving device; acceptance of the first operating signal by a signal path; generation, by a first signal processing, of a second operating signal that is derived from the respective signal echo and the first operating signal, the respective signal echo being characterized by at least one signal parameter, a second signal processing providing the at least one signal parameter with a variation; and conversion of the second operating signal into a second signal and sending of the second signal by a transmitting device.

The simulation device for the surroundings sensor system or the method for operating a simulation device for such a surroundings sensor system has the advantage that a correct simulation with appropriate plausibility checking and classification for radar sensors or alternative surroundings sensors, for example lidar sensors, is possible. The present patent application is based on the finding that in reality, signal echoes have a certain lack of sharpness. This is also referred to as flickering, and is caused, for example, by movement of the objects or of air layers that are present between an object and a sensor. Other influencing factors may also play a role here. Effects such as flickering may be utilized by evaluation modules for such surroundings sensors in order to assess the plausibility of signal echoes and classify them into certain object types, for example passenger vehicle, motorcycle, bicycle, or pedestrian. It is therefore advantageous when a simulation device for such sensors can simulate realistic surroundings including realistic objects. In addition to a high approximation of reality, it is thus also possible to test capabilities of the sensor with regard to the evaluation of such effects.

A signal echo, for example a radar echo or lidar echo, is the reflection of signals, sent by the surroundings sensor system, on a particular object. For a simulated object, such a signal echo is emulated, i.e., recreated, by the simulation device.

According to an example, a simulation device may be understood to mean a device in which the surroundings sensor system is mounted or inserted in order to check the surroundings sensor system for functionality and performance in various situations. A wide variety of situations may thus be tested without installing the surroundings sensor system in a vehicle, for example, and actually running through these situations. The surroundings sensor system is a so-called “device under test,” and may be cost-effectively tested using the simulation device.

The surroundings sensor system in the present case may be a radar sensor system or a lidar sensor system or also a combination of the two, as well as other surroundings sensor systems that operate using signal echoes and that can be checked according to the present patent application. A radar sensor system sends microwaves, for example, and based on these sent microwaves receives signal echoes that are reflected on objects. Distance information concerning objects may be obtained from propagation time measurements or skillful evaluation of the emitted and received signals. In applications in vehicles, a frequency shift based on the Doppler effect is often used, from which, in addition to distance information, for example also information concerning a relative speed may be obtained. Properties of the object on which the reflection takes place may be obtained by evaluating the signal strength of the echo. Lidar sensors utilize laser light, preferably in the infrared range, instead of microwaves.

The surroundings sensor system can be configured to detect a particular object based on the respective signal echo. The object can be, for example, another vehicle, a pedestrian, a motorcycle, or a bicycle. Such a surroundings sensor system may be used in particular for assisted or autonomous driving, as well as emergency braking functions or driving assistants already in use.

Accordingly, the signal echo can be understood to mean the reflection on a signal that is sent from the surroundings sensor system, on the basis of which the object is detected, for example by recognizing the location and the motion vector of the object.

The simulation device now includes a receiving device that is configured to receive a first signal that is used by the surroundings sensor system and to convert it into a first operating signal. The signals sent by a radar, for example, have been sent, for example, in the microwave range at 77 GHz, for example; therefore, the receiving device then includes a corresponding receiver that can receive and process such a microwave signal. The receiving device converts the received first signal into a first operating signal. The first signal is converted into a lower frequency than the frequency of the first signal to make it easier to process electronically. Therefore, the first operating signal is then provided on a signal path that is connected to the receiving device for accepting the first operating signal.

The signal path can refer to the signal processing chain, and for this purpose has a first signal processing, which forms a second operating signal that is derived from the respective signal echo and the first operating signal. The desired signal echo is intended to simulate an appropriate object and the reflection of the first signal on this object. This may take place, for example, by modulating at least one signal parameter of the first operating signal. Such a signal parameter characterizes the signal echo; this signal parameter is defined in greater detail according to the dependent claims.

Information concerning the signal echo and values for the signal parameter(s) of the signal echo may be supplied to the signal path, in particular via an interface. Information concerning the signal echo may, for example, be generated from a test program or input manually.

The generation of the second operating signal may take place by modulating the first operating signal, using at least one signal parameter of the signal echo. It is likewise possible to generate the second operating signal anew, taking into account the information from the first operating signal and the signal echo.

In addition, a second signal processing can be provided in the signal path. The second signal processing is provided to provide the at least one signal parameter with a variation. That is, the second operating signal is provided with the variation by means of the second signal processing, by providing the at least one signal parameter of the signal echo with a temporal change.

Therefore, a two-stage signal processing can be present: initially, signal parameters of the desired signal echo are applied to the first operating signal, and the second operating signal is generated. The incorporation may take place by modulation, for example. In a second step, the at least one signal parameter of the signal echo in the second operating signal is then provided with the variation. In this way, the desired “jitter” in the simulation devices may be applied to the second operating signal.

The first and the second signal processing may be implemented on processors; however, dedicated hardware may also be used. In particular, the first and the second signal processing may be designed as software. In one advantageous embodiment, the first and the second signal processing are implemented on the same hardware, for example even on the same processor. The first and the second signal processing may be carried out in succession.

A transmitting device can be provided for converting the second operating signal, which thus contains the variation of the least one signal parameter of the signal echo, into a second signal. This second signal is then sent by the transmitting device to the surroundings sensor system. The reflection on an object is thus generated by the simulation device according to the present patent application or the method according to the present patent application for operating such a simulation device, and the surroundings sensor system may thus simulate any desired objects. Consequently, the transmitting device converts, for example, the second operating signal into a frequency range in which the first signal has been received. For this purpose, the transmitting device for a radar sensor may include an appropriate microwave electronic circuit, for example. For a lidar sensor, the transmitting device may be designed as an optical transmitting device.

Advantageous enhancements of the simulation device or of the corresponding method for operating such a simulation device are possible by means of the measures and refinements set forth in the dependent claims.

The second signal processing can have an interface for receiving an input signal, and the second signal processing is configured to generate the variation as a function of the input signal. That is, the second operating signal is provided with the variation by the second signal processing, by providing the at least one signal parameter of the signal echo with a temporal change. The temporal change can be generated as a function of the input signal, which, for example, is generated from a test program or entered manually. This allows the simulation device to be integrated into an all-encompassing test concept in which jitter is incorporated into the signal echo in a targeted manner.

It is proposed that the first signal processing can be configured to generate a delay and/or a signal strength and/or a signal frequency as the at least one signal parameter. By use of these parameters, the first operating signal may be changed, individually or in combination. This means that, for example, a delay in the first operating signal is incorporated to simulate a certain distance of the simulated object from the sensor. Alternatively or additionally, the signal strength, i.e., amplitude, of the first operating signal may be influenced in a targeted manner in order to simulate certain object properties, for example a surface characteristic and/or a size of the simulated object. The amplitude and thus the signal strength are modulated corresponding to the desired radar cross section of the object or objects. Alternatively or additionally, the signal echo may, for example, have a different frequency than the first operating signal; i.e., the frequency of the first operating signal is changed, i.e., modulated, to simulate a relative movement of the simulated object with respect to the sensor. A movement of the particular simulated object toward the surroundings sensor system may thus be simulated by a frequency increase corresponding to the Doppler effect.

The second signal processing can be configured to generate the variation periodically and/or in a randomized manner and/or for a specified time period. By use of these alternatives, which may also be applied at the same time, it is possible to simulate various effects of the variation. In this regard, “periodically” can mean that the variation repeats in a predefined time grid. “Randomized” can mean that the variation occurs, at least approximately, according to a random pattern. This may be determined by a pseudorandom generator, for example. In addition, it is possible for a variation to be provided only for a specified time period.

Furthermore, it is proposed that the second signal processing can be configured to determine a magnitude for the variation, i.e., a deviation in the variation or the degree of variation. In particular, the magnitude of the variation may be determined as a function of the input signal. Alternatively or additionally, a repetition frequency of the variation may be determined. In particular, the repetition frequency of the variation may be determined as a function of the input signal. For example, signal echoes from various objects or other effects may be taken into account in this way.

It is possible for the first signal processing to have a digital and/or analog design. In particular, the frequency and/or the signal strength of the signal echo that is applied to the first operating signal may thus be generated in a digital and/or analog manner. For the generation of a time delay, in an analog design the first signal processing may have delay elements that can be switched on. The delay elements may include lines via which the second operating signal is sent. The second operating signal then undergoes the time delay by passing through the delay element.

It is possible for the second signal processing to have a digital and/or analog design. In particular, the variation, also referred to as “jitter,” for the frequency and/or the signal strength of the signal echo may thus be generated in a digital and/or analog manner. For the generation of the variation, also referred to as jitter, of the time delay, a second signal processing in an analog design may include delay elements that can be flexibly switched on. The delay elements may include lines via which the second operating signal is sent. The second operating signal then undergoes the time delay by passing through the delay element. The desired variation may thus be generated by flexibly switching the delay elements on and off.

The signal parameters of the signal echo and the particular desired variation may be generated together. This is possible, for example, when the first and the second signal processing are implemented jointly, and longer and shorter delay elements are alternately switched on and off. A time delay with a variation may thus be generated. The same applies for the method claims.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic design of a simulation device;

FIG. 2 shows a diagram with a schematic illustration of a signal echo;

FIG. 3 shows a block diagram of a signal processing chain;

FIG. 4 schematically shows the use of delay elements; and

FIG. 5 shows a method for operating the simulation device.

### DETAILED DESCRIPTION

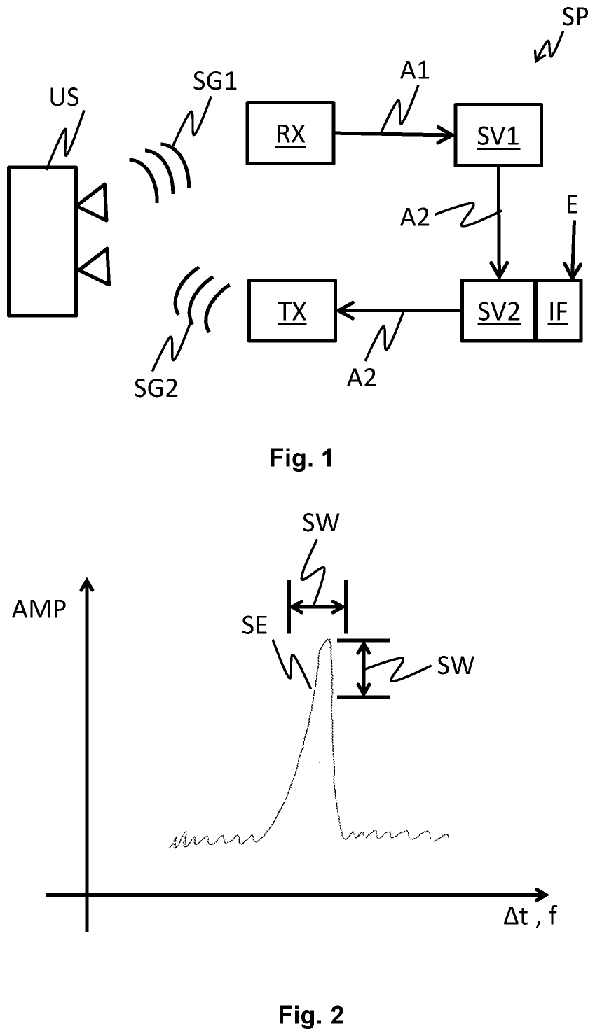

FIG. 1 schematically shows the design of a simulation device. The surroundings sensor system US, as a device under test, sends a first signal SG1 to a receiving device RX, which converts the first signal SG1 into a first operating signal A1 and provides it on a signal path SP that includes the signal processing SV1, SV2 described below. The first signal SG1 is an electromagnetic wave, and has a frequency in the microwave range or in the optical infrared range, for example, depending on the type of surroundings sensor system US. The receiving device RX is designed to convert the first signal SG1 into a baseband signal for simpler further processing as the first operating signal A1.

The second operating signal A2 is generated in the first signal processing SV1, using the first operating signal A1 and a desired signal echo SE. The desired signal echo SE is a representation of the object to be simulated, with regard to, for example, distance, relative speed, and/or other properties such as size and/or surface characteristics. The signal echo SE is characterized in particular by one or more signal parameters such as. the signal strength AMP, the frequency f, and/or a time delay Δt.

The generation of the second operating signal A2 may take place, for example, by providing the first operating signal A1 in the first signal processing SV1 with the desired parameter(s) of the signal echo SE. Signal parameters, which are a function of the signal echo SE, are applied to the first operating signal A1 with regard to signal strength AMP and/or frequency f and/or delay Δt. A modulation thus takes place. The second operating signal A2 arises therefrom, namely, from this modulation.

Alternatively or additionally, the second operating signal A2 may be generated as a new signal. The appropriate pieces of information from the first operating signal A1 and the desired signal echo SE are then used for this purpose, and a corresponding second operating signal A2 is generated therefrom.

The signal path SP also includes the second signal processing SV2, which adds a variation SW to the first operating signal A1, and in particular to the contained signal parameter(s) of the signal echo SE, in order to simulate the above-mentioned jittering. This variation SW is determined via an input signal E, the input signal E being accepted by the second signal processing SV2 via the interface IF. The second operating signal A2 modified in this way is then transferred to the transmitting device TX, the transmitting device TX converting the second operating signal A2, thus further processed, into a second signal SG2, which is then sent to the surroundings sensor system US via an antenna or radiation source, and which can be received by this surroundings sensor system US. For this purpose, the transmitting device TX includes in particular high-frequency components for generating high-frequency waves, in particular in the microwave or infrared range. Accordingly, via the signal path SP a corresponding signal echo SE for the surroundings sensor system US is generated which, as an integral component of the second signal SG2, may be received by the surroundings sensor system US, and an object may thus be simulated via the signal parameters of the signal echo SE.

An example of the signal echo SE of an object is schematically plotted with respect to a delay Δt or a frequency f in FIG. 2. Also illustrated is the variation SW, via which the delay Δt and/or the frequency f may be provided. This variation SW in the horizontal direction of FIG. 2 corresponds to a variation of the delay Δt and/or the frequency f. Also illustrated is the variation SW via which the signal strength AMP, i.e., the amplitude, may be provided. This variation SW in the vertical direction of FIG. 2 corresponds to a variation of the signal strength AMP.

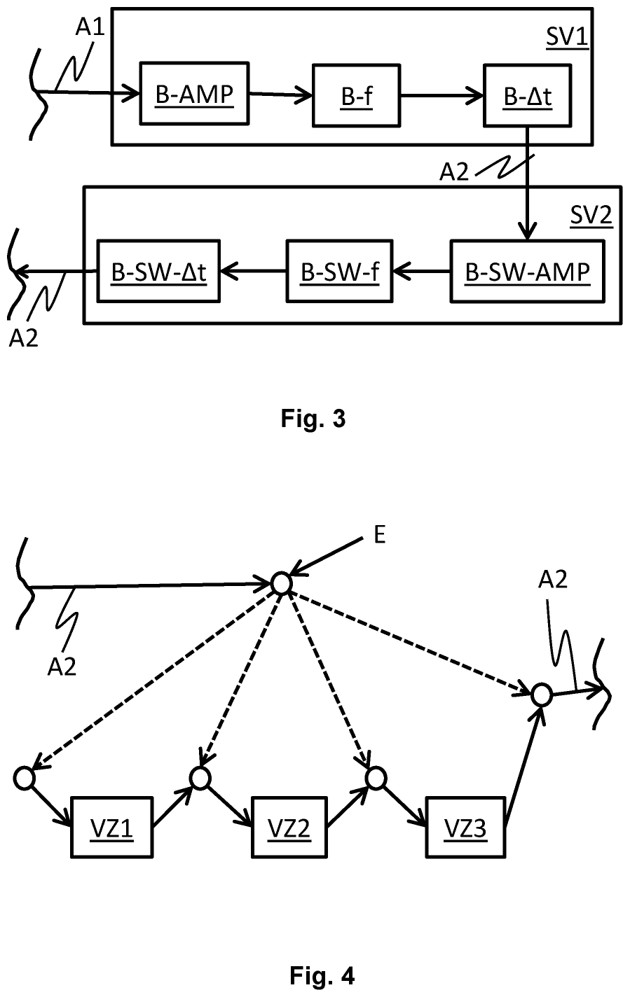

FIG. 3 shows, in a block diagram, a portion of the method for operating the simulation device, as a block diagram of a portion of the signal processing chain. In the first signal processing SV1 the first operating signal A1 is changed with regard to the amplitude, i.e., the signal strength AMP, in block B-AMP. The first operating signal is changed with regard to the frequency f in block B-f, and a time delay Δt is added to the signal in block B-Δt. It is possible to incorporate all three of these parameters, or also only one or two of them, into the first operating signal A1. The signal echo SE is applied via these parameters. This results in the second operating signal A2. Alternatively, it is also possible to generate the second operating signal A2 anew, and for this purpose to use information of the first operating signal A1 and the signal echo SE.

This second operating signal A2 is subjected to variations SW in the second signal processing SV2, in particular with regard to the signal strength AMP in block SW-AMP, with regard to its frequency f in block SW-f, and with regard to its delay in block SW-Δt. It is possible for only the parameters that were applied in the first signal processing SV1 to also be provided with the variation SW. The changes in the respective operating signals A1 and A2 are made in both the first signal processing SV1 and in the second signal processing SV2, based on predefined parameters that are taken from a simulation program, for example. It is possible for the processing blocks in the first signal processing SV1 and in the second signal processing SV2 to each run in parallel to one another. It is also possible for the first and the second signal processing SV1, SV2 to be carried out together as one signal processing, and for the described steps to take place in parallel or in succession.

FIG. 4 schematically shows the analogous addition of delays Δt by the delay elements VZ1, VZ2, or VZ3. The second operating signal A2 is supplied to only one of the delay elements VZ1, VZ2, or VZ3 or to all or none of the delay elements VZ1, VZ2, and VZ3, or also to only two of the delay elements, as a function of the input signal E. Since it is provided that the delay element VZ1, VZ2, or VZ3 may incorporate different delays Δt, a variation SW of the delays Δt may thus be generated.

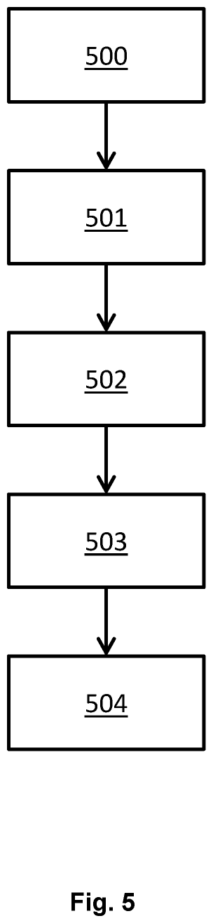

FIG. 5 shows the method in a flow chart. The reception of the first signal SG1 by the receiving device RX takes place in method step 500. The first operating signal A1, derived from the first signal SG1, is converted by the receiving device RX in method step 501. This first operating signal A1 is accepted by the signal path SP in method step 502. The application of the signal parameter of the signal echo SE to the first operating signal A1 takes place in method step 503, for example by changing the signal parameters signal strength AMP, frequency f, and/or time delay Δt. Thus, the second operating signal A2 is then present. The signal parameter(s) AMP, f, Δt changed in method step 504 is/are subsequently provided with a variation SW by the second signal processing SV2. The second operating signal A2 modified in this way is then converted into the second signal SG2 in method step 505 in order to then send it to the surroundings sensor system US.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A simulation device for a surroundings sensor system configured to detect at least one particular object based on a respective signal echo, the simulation device comprising:
a receiving device that is configured to receive a first signal that is sent from the surroundings sensor system and to convert it into a first operating signal;
a signal path that is connected to the receiving device for accepting the first operating signal, the signal path being configured to generate, via a first signal processing, a second operating signal that is a function of the first operating signal and the respective signal echo, the respective signal echo comprising at least one signal parameter, wherein a second signal processing provides the at least one signal parameter with a variation; and
a transmitting device that is configured to convert the second operating signal into a second signal and to send the second signal to the surroundings sensor system.

2. The simulation device according to claim 1, wherein the second signal processing has an interface for receiving an input signal, and wherein the second signal processing is configured to generate the variation as a function of the input signal.

3. The simulation device according to claim 1, wherein the first signal processing is configured to generate a delay and/or a signal strength and/or a signal frequency as the at least one signal parameter.

4. The simulation device according to claim 1, wherein the second signal processing is configured to generate the variation periodically and/or in a randomized manner and/or for a specified time period.

5. The simulation device according to claim 1, wherein the second signal processing is configured to determine a magnitude of the variation and/or a repetition frequency of the variation, the determination taking place in particular as a function of the input signal.

6. The simulation device according to claim 1, wherein the first signal processing has a digital and/or analog design, and wherein the second signal processing has a digital and/or analog design.

7. The simulation device according to claim 6, wherein for the analog design, the simulation device further comprises delay elements adapted to be switched on and via which the signal echo and/or the variation are generated.

8. A method for operating a simulation device for a surroundings sensor system configured to detect at least one particular object based on a respective signal echo, the method comprising:
receiving a first signal sent by the surroundings sensor system, by a receiving device;
converting the first signal into a first operating signal by the receiving device;
accepting the first operating signal by a signal path;
generating, by a first signal processing, a second operating signal that is derived from the respective signal echo and the first operating signal, the respective signal echo comprising at least one signal parameter, wherein a second signal processing provides the at least one signal parameter with a variation;
converting the second operating signal into a second signal; and
sending the second signal via a transmitting device.

9. The method according to claim 8, wherein the second signal processing generates the variation as a function of an input signal.

10. The method according to claim 8, wherein a delay and/or a signal strength and/or a signal frequency are/is generated by the first signal processing as the at least one signal parameter.

11. The method according to claim 8, wherein the variation is generated periodically and/or in a randomized manner and/or for a specified time period by the second signal processing.

12. The method according to claim 8, wherein a magnitude of the variation and/or a repetition frequency of the variation are/is determined by the second signal processing, the determination taking place as a function of the input signal.

13. The method according to claim 8, wherein, for an analog design of the first and/or the second signal processing, delay elements are switched on.
